(19) United States
(12) Patent Application Publication
(10) Pub. No.: US 2009/0144554 A1
(43) Pub. Date: Jun. 4, 2009

(54) Two-way authentication with non-disclosing password entry

(75) Inventor: Daniel G. Baker, Beaverton, OR (US)

Correspondence Address: Lipsitz & McAllister, LLC, 755 MAIN STREET, MONROE, CT, 06468, US

(73) Assignee: Next Access Technologies, LLC, Stamford, CT (US)

(21) Appl. No.: 12/215,938

(22) Filed: Jul. 1, 2008

Related U.S. Application Data
(60) Provisional application No. 60/961,013, filed on Jul. 19, 2007.

(51) Int. Cl. H04L 9/32

(52) U.S. Cl. 713/183

(57) ABSTRACT

A method of two-way authentication between a user and a known host using a non-disclosing password entry system generates a matrix of characters having a random characteristic with random characteristics being selected from a set of custom symbols, pictures or patterns (rather than alpha-numeric characters) that only the user recognizes. When the user sets up an account with the known host, a subset of these characteristics is predetermined for use specifically by the user. One or more of these may additionally be used in the user's PIN or password for easy memorization, allowing the user to first authenticate the log-in screen before the user enters the PIN for user authentication to the known host. Alternatively, randomized alpha-numeric characters may be used, but with a predefined grouping or subset of the characters in a predefined position on the initial character matrix presentation. If the user doesn't see the predefined special characters or figures in the character matrix, or the particular alpha-numeric subset in the character matrix, then the log-in screen is recognized as a fake.

### BACKGROUND OF THE INVENTION

The present invention relates to password authentication, and more particularly to an improved method of two-way authentication with non-disclosing password entry.

It has long been known that the best way to identify an authorized user at a secure access point while minimizing the chances of an imposter gaining access is to base the identification on three basic items; something the authorized user has, something the authorized user is, and something the authorized user knows. The first one, something the authorized user has, is often accomplished by an ID card with electronically readable magnetic strip or, more recently, a Radio Frequency Identification (RFID) chip. The second, something the authorized user is, may be a finger print, retinal scan or some other unique biologic trait of the valid user. However, biologic ID is still new and not shown to be fully robust in allowing the authorized user access in all conditions. Therefore, these methods are used only where security is paramount. The last, something the authorized user knows, is quite often a password or Personal Identification Numbers (PIN). This password method is used by virtually everyone and remains the most common method of authentication of identity. The password or PIN is something only the authorized user knows and, with today's strong encryption, the password may be transmitted over a network to authenticate the authorized user with little fear of the password being compromised by unauthorized eavesdroppers or imposter.

However, although the password may be securely transmitted in the presence of imposters by the use of encryption, the password may still be disclosed to an imposter before or during the password entry process. For example, many ATM keypads are visible to people waiting in line where an imposter may observe the keypad selections and obtain the authorized user's PIN simply by looking over their shoulder (called “shoulder-surfing”). Alternatively, a secluded imposter may obtain the password by watching with binoculars from a nearby car or building.

Passwords are also the dominant means of user authentication via the keyboard or mouse of a computer. It may be more difficult for an imposter to see and memorize the password by watching the authorized user's fingers at the keyboard or mouse icon position on the screen than watching an ATM keypad, but it does happen. Also small cameras may be placed and removed to allow all the authorized user's keyboard strokes and mouse display clicks to be recorded for later playback.

Also, the disclosure of passwords is a serious issue with computer keyboard or mouse selection entry of passwords when using a device connected to the internet. For example, a common method of password theft is now being done by a simple spy-ware program that logs keystrokes and/or mouse screen position clicks and sends that log back over the internet without the authorized user's knowledge. This log may then be filtered to find account numbers and passwords.

U.S. Pat. No. 5,428,349, entitled “Non-disclosing Password Entry System” and issued to Daniel G. Baker on Jun. 27, 1995, discloses a method of securely entering a password as a means to authenticate a user log-in to a secure data service. The method disclosed in the '349 patent is that of selecting the row or column of a randomized (shuffled) matrix of alpha-numeric characters that contains each, in succession, of the characters of the user password. The characters of the password are not selected or typed, since only row or columns of the matrix are selected. Therefore, the '349 patent discloses a system that is resistant to all the aforementioned problems, since it does not explicitly disclose the password by the key press or mouse click entry process.

However, there is a growing problem with password theft by the method of presenting a fake or duplicate log in screen, called a “Trojan Horse”. This duplicate looks just like the one the user normally sees when the user enters the user's account number and password, but is a fake to capture the user's vital information. Using the method of the '349 patent, the password is not explicitly entered, so there is little or no danger of a Trojan Horse type web page capturing the user password. However, it is desirable to recognize a Trojan web page presenting the randomized matrix of the patented method since, after repeated use, the Trojan Horse may capture enough trials to allow the originator of the Trojan Horse to guess one or more of the password characters. It is also desirable to expose these fake pages to stop people from “phishing” for passwords.

Therefore, although the '349 patent prevents full disclosure of the user's password to the host of the Trojan web page, it does not provide a method to authenticate the true host and expose the duplicate or fake log in screen. The authentication of the host or authentication authority to the user, as well as the user authentication, is commonly called “two-way authentication.” What is needed is an improvement to the '349 patent that allows authentication of the host as well as the user.

### BRIEF SUMMARY OF THE INVENTION

Accordingly the present invention provides two-way authentication between a user and a known host in a non-disclosing password entry system using randomized characteristics from a set of custom symbols, pictures or patterns (rather than alpha-numeric characters) that only the user recognizes. When the user sets up an account with the known host, a subset of these characteristics may be predetermined for use specifically by the user. One or more of these may additionally be used in the user's PIN or password for easy memorization, allowing the user to first authenticate the log-in screen before the user enters the PIN for user authentication to the host. Alternatively, randomized alpha-numeric characters may be used, but with a predefined grouping or subset of the characters in a predefined position on the initial character matrix presentation. If the user doesn't see the predefined special characteristics or figures in the character matrix, or the particular alpha-numeric subset, in the character matrix, then the log-in screen is recognized as a fake.

The objects, advantages and other novel features of the present invention are apparent from the following detailed description when read in conjunction with the appended claims and attached drawing.

### BRIEF DESCRIPTION OF THE SEVERAL VIEWS OF THE DRAWING

FIGS. 1a and 1b are plan views of initial character matrices for two-way authentication having a given authentication word at a predefined location according to the present invention.

FIG. 2 is a plan view of yet another initial character matrix having a more random group of characters for two-way authentication according to the present invention.

### DETAILED DESCRIPTION OF INVENTION

A method of two-way authentication that improves on U.S. Pat. No. 5,428,349, the specification of which patent is expressly included herein by reference, or with co-pending U.S. Patent Application Ser. No. 60/962,016, the specification of which is expressly included herein by reference, is described below.

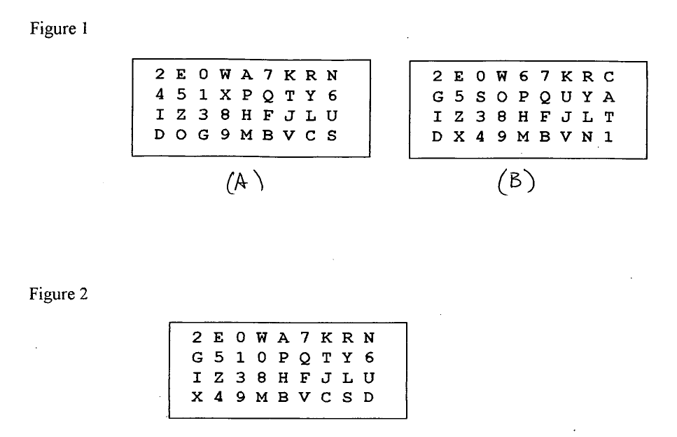

When a user sets up an account with a host or authenticating authority, a key word of non-repeated characters, letters, symbols, patterns or other characteristics is chosen by the user from a large set of possible characteristics. It may be as simple as a single character or symbol to be placed at a pre-defined position of a character matrix, as described in the '349 patent. Another possibility is a pre-defined word or sequence of characters or symbols chosen during account set up. For example, it may be the word DOG at the beginning of the bottom row of the character matrix (FIG. 1a) or, in a second example, the character sequence CAT1 down the right-most column (FIG. 1b are two possible configurations. Alternatively it might be a specific background pattern for the characters in the character matrix.

After the user logs into the authentication screen or webpage by typing in the appropriate user ID or using an ID card, the password entry process begins with the display of the improved character matrix, such as shown in FIGS. 1 and 2, whereby, rather than a fully random matrix of characters as disclosed in the '349 patent, there is contained within the character matrix the predefined word or symbol arrangement at a specific location within the character matrix. The authenticating authority assigns and presents the predefined arrangement to that particular user by association to the user's ID. The rest of the characters within the initial character matrix are otherwise randomized, as in the '349 patent. For example, the user of the display in FIG. 2 has predefined a ham radio call sign, WA7KRN, to be presented at the end of the first row of the initial character matrix used in the password entry session.

The user then looks at the initial character matrix for the predefined word, character pattern, or particular character position before selecting the row or column, as disclosed in the '349 patent. If the predefined word, character position or pattern is not seen, then the user knows this is a fake or Trojan web page and exits the session. In this case, the authenticating authority may be alerted to the imposter web page and take action. Otherwise, the authenticating authority has itself been authenticated and the user authentication can proceed, as in the '349 patent. The subsequently presented matrices of characters used in the password entry process may then be fully random, as described in the '349 patent, to avoid disclosure of the user password.

The improvement to the '349 patent is described above by example, but it is recognized that variations of this example are obvious to one of ordinary skill in the art. For example, although this example uses characters from the set of alpha-numeric English language characters, the '349 patent is not restricted to these, and any set of characters or symbols may be used.

For two-way authentication in the non-disclosing password entry system as described in co-pending '016 patent application, where the character matrix is fixed, but the character backgrounds are variable, a specific pattern of backgrounds, or the like, may be used as the predefined grouping.

Thus the present invention provides improved non-disclosing password entry by using two-way authentication to assure that a user is interacting with a proper host or authorizing authority prior to entering the user's password. The authentication is achieved by inserting into an initial randomized character matrix a predefined grouping of characteristics within the character matrix, which grouping is known only to the user.

1. An improved non-disclosing password entry method for two-way authentication between a user and a known host of the type having a randomized characteristic, where each character of an authentication code in sequence is selected via a specific characteristic of a character matrix, the randomized characteristic being re-randomized after each entry of the specific characteristic associated with a character of the authentication code, wherein the improvement comprises the step of initializing the character matrix with the randomized characteristic to have a specified grouping of a subset of characteristics within the character matrix, the grouping being associated with the user, to assure that the user is interacting with the known host.

2. A non-disclosing password entry method comprising the steps of:
requiring a user to choose a key word;
generating a character grouping for entry of a password by said user, said grouping having a randomized portion and a non-randomized portion, said non-randomized portion comprising said key word; and
presenting said character grouping to said user for entry of said password;
wherein:
the presence of said key word in said character grouping provides assurance to the user that the user is interacting with a known host, and
the absence of said key word in said character grouping provides a warning to the user not to enter said password.

3. A non-disclosing password entry method in accordance with claim 2 wherein said key word is unique to said user.

4. A non-disclosing password entry method in accordance with claim 2 wherein said key word comprises at least one of characters, letters, symbols, or patterns.

5. A non-disclosing password entry method in accordance with claim 4 wherein said characters, letters, symbols or patterns in said key word are non-repeating.

6. A non-disclosing password entry method in accordance with claim 2 wherein said character grouping comprises a matrix of characters.

7. A non-disclosing password entry method in accordance with claim 6 wherein said matrix resembles a key pad.

8. A non-disclosing password entry method in accordance with claim 6 wherein said password is entered by choosing rows or columns of said matrix in which successive characters of the password are contained.

9. A non-disclosing password entry method in accordance with claim 2 wherein:
said character grouping having said key word is presented to the user for entry of a first character of said password, and
subsequent fully random character groupings that do not have said key word are presented to the user for entry of subsequent characters of said password.

10. A non-disclosing password entry method in accordance with claim 2 wherein said key word is a secret word known only to said user.

11. A non-disclosing password entry method in accordance with claim 2, wherein:
said user is required to choose said key word when setting up an account, and
once chosen, the same key word is automatically provided in the non-randomized portion of said character grouping generated for that user each time the user attempts to gain access to said account.

12. A system for allowing a user to safely enter a password, comprising:
a key word generator that requires said user to choose a key word upon setting up an account;
a character generator that generates a character grouping having a randomized portion and a non-randomized portion, said non-randomized portion comprising said key word when said grouping is generated for said user; and
a display coupled to said character generator for displaying said grouping to said user when said user desires to access said account;
wherein:
the presence of said key word in said character grouping provides assurance to the user that the user is interacting with a known host, and
the absence of said key word in said character grouping provides a warning to the user not to enter said password.

13. A system in accordance with claim 12 wherein said key word is unique to said user.

14. A system in accordance with claim 12 wherein said key word comprises at least one of characters, letters, symbols or patterns.

15. A system in accordance with claim 14 wherein said characters, letters, symbols or patterns in said key word are non-repeating.

16. A system in accordance with claim 12 wherein said character grouping comprises a matrix of characters.

17. A system in accordance with claim 16 wherein said matrix resembles a key pad.

18. A system in accordance with claim 16 wherein said password is entered by choosing rows or columns of said matrix in which successive characters of the password are contained.

19. A system in accordance with claim 12 wherein:
said character grouping having said key word is presented to the user for entry of a first character of said password, and
subsequent fully random character groupings that do not have said key word are presented to the user for entry of subsequent characters of said password.

20. A non-disclosing password entry method in accordance with claim 12 wherein said key word is a secret word known only to said user.
